(19) United States
(12) Patent Application Publication
(10) Pub. No.: US 2025/0103999 A1
(43) Pub. Date: Mar. 27, 2025

(54) INFORMATION PROCESSING SYSTEM AND SERVER, INFORMATION PROCESSING METHOD, AND PROGRAM

(71) Applicant: AERONEXT INC., Tokyo (JP)

(72) Inventors: Tadanari HIGUCHI, Ogaki-shi (JP); Shuji KAWAI, Tokyo (JP); Kento KONDO, Tokyo (JP); Keisuke TOJI, Tokyo (JP); Takuya HORI, Tokyo (JP)

(21) Appl. No.: 18/725,005

(22) PCT Filed: Dec. 27, 2022
(86) PCT No.: PCT/JP2022/048128

§ 371 Date: Jul. 9, 2024

(30) Foreign Application Priority Data
Dec. 27, 2021 (JP) 2021-212590

(51) Int. Cl. G06Q 10/083

(52) U.S. Cl. CPC G06Q 10/083

(57) ABSTRACT

This disclosure comprises a residual space calculation part that, based on storage container type information indicating the type of storage container for storing delivery payloads to users and reference storage space volume information indicating the volume of the storage space that stores the storage container, calculates residual space information indicating the residual space within the storage space; and a delivery schedule determination part that, based on at least the residual space information and a predetermined condition related to the delivery, determines the delivery schedule for the delivery payload information.

### TECHNICAL FIELD

This disclosure relates to information processing systems and servers, information processing methods, and programs.

### BACKGROUND ART

In recent years, autonomous-controlled moving objects such as flying objects such as drones (drones) and unmanned aerial vehicles (UAVs) and moving objects such as unmanned ground vehicles (UGVs) have begun to be used in industry. Patent Literature 1 discloses the delivery of delivery payloads using flying objects.

### PRIOR ART LIST

### Patent Literature

[Patent Literature 1] JP2021-160887A

### SUMMARY OF THE INVENTION

### Technical Problem

As disclosed in Patent Literature 1, in such a delivery system, it is assumed that multiple moving objects will be the delivery control target. However, in the demonstration experiment, a test delivery flight is performed by setting a virtual delivery load (e.g., daily necessities, food, etc.) within the range that can be loaded onto a single moving object, and at a time when the predetermined route can be flown.

However, in reality, users do not usually order items while being aware of the load capacity of a single moving object, and they usually order the items they want in the quantities they want at the times they want them, so there is no way of predicting how much can be loaded onto a single moving object (in other words, how much of the residual space in the storage part of the moving object, etc., is available). On the other hand, it is known that high delivery efficiency leads to lower delivery costs (and therefore lower delivery fees), so it is desirable for both the service provider and the user to be able to load as much as possible onto a single moving object. These issues are not limited to moving objects, but also apply to conventional delivery methods.

In light of this background, the present disclosure aims to provide an information processing system and server, an information processing method, and a program that make it easier to comprehensively grasp the quantity of delivery payloads (e.g., loads such as packages) by standardizing and managing them using storage container type identification information, thereby enabling efficient storage in various containment spaces.

### Technical Solution

The main technology of this disclosure for solving the above problem is an information processing system or the like that includes: a residual space calculation part that, based on storage container type information indicating the type of container for storing a delivery payload for a user according to the volume of the container, and reference storage space volume information indicating the volume of the storage space that contains the storage container, calculates residual space information indicating the remaining space within the aforementioned storage space; a delivery schedule determination part that, based on at least the residual space information and predetermined conditions related to the delivery, determines the delivery schedule for the delivery payload.

### Advantageous Effects

According to the present disclosure, by using storage container type information to standardize and manage delivery payloads (e.g., loads such as packages), it is possible to provide an information processing system and server, information processing method, and program that facilitate the comprehensive understanding of the quantity of delivery payloads and enable efficient storage in various storage spaces.

### BRIEF DESCRIPTION OF THE DRAWINGS

FIG. 1 shows a configuration of an information processing system in this embodiment of the present disclosure.

FIG. 2 shows a block diagram of the hardware configuration of the management server in FIG. 1.

FIG. 3 shows a block diagram of the hardware configuration of the user terminal and the operator terminal in FIG. 1.

FIG. 4 shows a block diagram of the functions of the management server in FIG. 1.

FIG. 5 shows a block diagram showing the structure of the storage in FIG. 2.

FIG. 6 shows an example that explains a calculation of residual space in this embodiment of the present disclosure.

FIG. 7 shows a block diagram showing the structure of the delivery information storage part in FIG. 5.

FIG. 8 shows a flowchart of the information processing method of this embodiment of the present disclosure.

FIG. 9 shows an example of a display screen for this embodiment of the present disclosure.

### SUMMARY OF THE INVENTION

The contents of this embodiment will be explained by listing them. The information processing system or the like of this embodiment comprises the following.

### [Item 1]

An information processing system, comprising:
a residual space calculation part that, based on storage container type information indicating the type of storage container for storing delivery payloads to users, and reference storage space volume information indicating the volume of the storage space that stores the storage container, calculates residual space information indicating the residual space within the storage space; and
a delivery schedule determination part that, based on at least the residual space information and a predetermined condition related to the delivery, determines the delivery schedule for the delivery payload.

### [Item 2]

The information processing system according to item 1,
wherein the storage container type information is made mutually identifiable based on the volume obtained by dividing the reference storage space volume by a predetermined number, with the predetermined storage space volume serving as the reference storage space volume.

### [Item 3]

The information processing system as in item 1 or item 2,
wherein the residual space information is residual conversion storage container type information that converts the residual space into storage container types.

### [Item 4]

The information processing system as in any one of items 1 to 3,
wherein the condition is an update condition that enables the updating of the delivery schedule.

### [Item 5]

The information processing system according to item 4,
wherein the update condition is that the user has approved a consolidation request from another user related to the user, and that it is not possible to store the delivery payload of the other user in the user's pre-update delivery schedule in time.

### [Item 6]

The information processing system according to item 4,
wherein the update condition is that the other user related to the user has approved a request for consolidation, and that it is not possible to store the other user's delivery payload in the user's pre-update delivery schedule.

### [Item 7]

The information processing system according to item 4,
wherein the update condition is that the delivery of the user is a subscription delivery with an automatically set delivery period, and that the storage of the other user's delivery payload cannot be completed in time for the user's pre-update delivery schedule.

### [Item 8]

The information processing system as in any one of items 1 to 3,
wherein the condition is an update restriction condition that does not allow the delivery schedule to be updated.

### [Item 9]

The information processing system according to item 8,
wherein the update restriction condition is that the temperature control range information linked to the user's delivery is information indicating a specified temperature control range other than normal temperature.

### [Item 10]

The information processing system according to item 8, wherein the update restriction condition is that the presence of perishable goods information linked to the user's delivery indicates that a perishable good is included.

### [Item 11]

The information processing system according to item 8,
wherein the update restriction condition is that the delivery type information linked to the user's delivery is information indicating express delivery.

### [Item 12]

The information processing system according to item 8,
wherein the update restriction condition is that the delivery type information associated with the user's delivery is information indicating a time-specified delivery.

### [Item 13]

The information processing system as in any one of items 1 to 3,
wherein the condition is whether the delivery linked to the user meets the condition of a consolidation target indicated in the consolidation target information.

### [Item 14]

The information processing system according to claim 13,
wherein the condition for the consolidation target is that the delivery for the target user is in the user-specified delivery time slot.

### [Item 15]

The information processing system according to claim 13,
wherein the condition for the consolidation target is that the other user who is requesting the consolidation is another user who permits the other user to bear at least part or all of the delivery costs.

### [Item 16]

The information processing system according to any one of items 1 to 15,
wherein when the delivery in the delivery schedule is consolidated with another user's delivery payload, the delivery charge information related to the user is divided between the other user and a predetermined ratio, and the delivery charge information after the division is stored linked to each user.

### [Item 17]

A server, comprising:
a residual space calculation part that, based on storage container type information indicating the type of storage container for storing delivery payloads to users and reference storage space volume information indicating the volume of the storage space that stores the storage container, calculates residual space information indicating the residual space in the storage space; and
a delivery schedule determination part that, based on at least the residual space information and predetermined conditions related to the delivery, determines the delivery schedule for the delivery payload.

### [Item 18]

An information processing method, comprising:
a step of, based on storage container type information indicating the type of storage container for storing the delivery payload to the user for each storage container volume and reference storage space volume information indicating the volume of the storage space that stores the storage container, calculating residual space information indicating the residual space within the storage space; and
a step of, based on at least the residual space information and predetermined conditions related to the delivery, determining the delivery schedule of the delivery payload.

### [Item 19]

A program for causing a computer to execute:
a step of, based on storage container type information indicating the type of storage container for storing the delivery payload to the user for each storage container volume and reference storage space volume information indicating the volume of the storage space that stores the storage container, calculating residual space information indicating the residual space within the storage space; and
a step of, based on at least the residual space information and predetermined conditions related to the delivery, determining the delivery schedule of the delivery payload.

### Embodiment 1

The following explains the information system or the like, based on the first embodiment of this disclosure. In the attached drawings, identical or similar elements are given identical or similar reference numerals and names, and in the description of each embodiment, duplicative descriptions of identical or similar elements may be omitted. In addition, the features shown in this embodiment are also applicable to other embodiments, as long as they do not contradict each other.

### <Configuration>

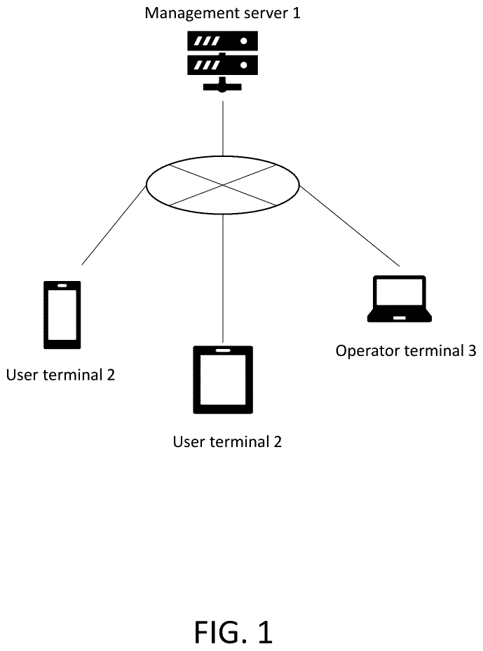

As shown in FIG. 1, the information processing system in this embodiment has a management server 1, one or more user terminals 2, and one or more user terminals 2. The management server 1, user terminals 2, and operator terminals 3 are connected to each other in a way that allows them to communicate via a network. The illustrated configuration is just one example, and is not limited to this.

### <Management Server 1>

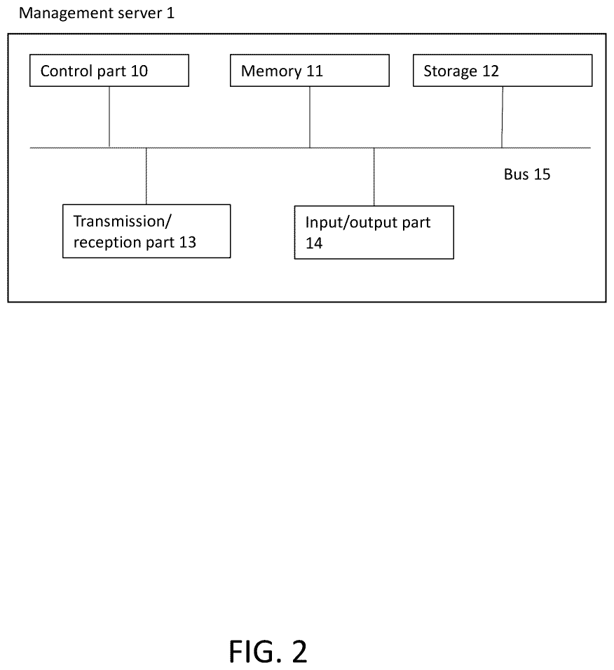

FIG. 2 shows the hardware configuration of the management server 1. Note that the configuration shown in the figure is just an example, and other configurations may be used.

As shown in the figure, the management server 1 is connected to one or more user terminal(s) 2 and one or more operator terminal(s) 3, and comprises part of the system. the management server 1 may be a general-purpose computer, such as a workstation or personal computer, or it may be logically realized through cloud computing.

At least a control part 10, a memory 11, a storage 12, a transmission/reception part 13, and an input/output part 14 are provided in the management server 1, and these are electrically connected to each other via a bus 15.

The control part 10 is a computing device that controls the overall operation of the management server 1, controls the transmission and reception of data between each element, and performs information processing necessary for executing applications and authentication processing. For example, the control part 10 is a CPU (central processing unit) and/or a GPU (graphics processing unit), and it executes programs for this system stored in the storage 12 and deployed in the memory 11 to perform each information processing.

The memory 11 comprises a main memory comprising a volatile storage device such as DRAM (dynamic random access memory), and an auxiliary memory comprising a non-volatile storage device such as flash memory or HDD (hard disk drive). The memory 11 is used as a work area or the like for the processor 10, and also stores the BIOS (Basic Input/Output System) that is executed when the management server 1 is started, as well as various setting information, etc.

The storage 12 stores various programs such as application programs or the like. A database storing data used in each process may be constructed in the storage 12.

The transmission/reception part 13 connects the management server 1 to the network and blockchain network. In addition, the transmission/reception part 13 may be equipped with a short-range communication interface for Bluetooth (registered trademark) and BLE (Bluetooth Low Energy).

The input/output part 14 is an input device such as a keyboard or mouse or the like, and an output device such as a display or the like.

The bus 15 is connected to each of the above elements in common, and transmits address signals, data signals, and various control signals, for example.

### <User Terminal 2, Operator Terminal 3>

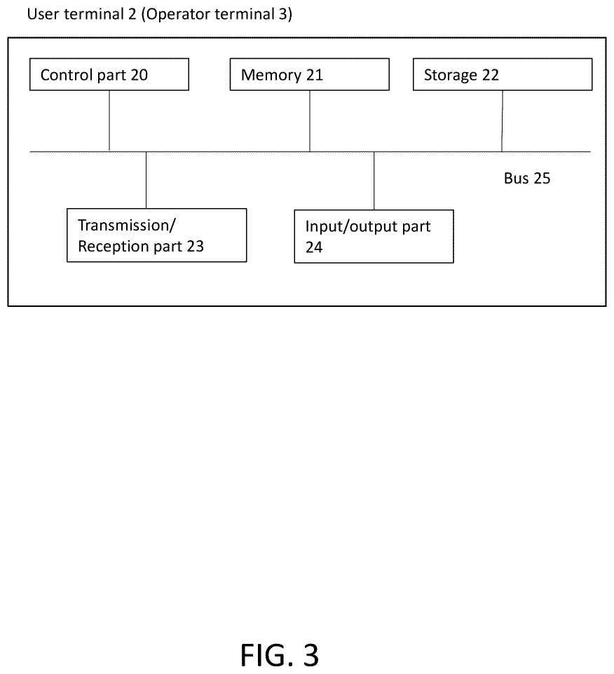

As shown in FIG. 3, a user terminal 2 is an information processing device, such as a personal computer, a tablet terminal, a smartphone, a mobile phone, a PHS, or a PDA, that is carried by a user. The user terminal 2 is also equipped with a control part 20, a memory 21, a storage 22, a transmission/reception part 23, and an input/output part 24, which are electrically connected to each other via a bus 25. As the main functions of each element can be comprised in the same way as the management server 1 described above, a detailed explanation of each element is omitted. In addition, an operator terminal 3 is an information processing device such as a personal computer, a tablet terminal, a smartphone, a mobile phone, a PHS, or a PDA, etc., which is carried by the operator who manages the delivery payload at a collection point, etc. The main functions of each element can be comprised in the same way as the user terminal 2 described above, so a detailed explanation of each element is omitted.

### <Functions of the Management Server>

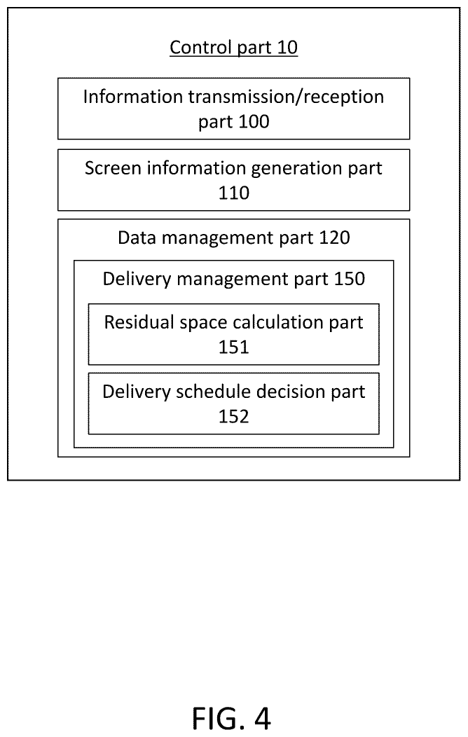

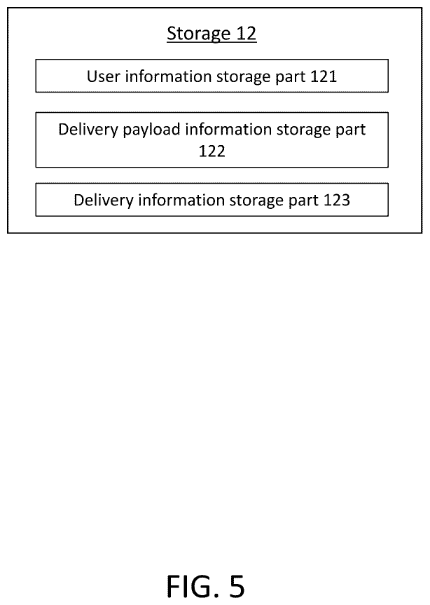

FIG. 4 is a block diagram illustrating the functions implemented in the control part 10 of the management server 1, and FIG. 5 is a block diagram illustrating the information stored in the storage 12. In this embodiment, the control part 10 of the management server 1 has the following function parts: information transmission/reception part 100, screen information generation part 110, data management part 120, and delivery management part 150. The delivery management part 150 includes a residual space calculation part 151 and a delivery schedule determination part 152. In addition, the storage 12 includes various databases such as a user information storage part 121, a delivery payload information storage part 122, and a delivery information storage part 123.

User information stored in a user information storage part 121 may include, for example, basic user information (such as the user's name, user name, email address, address, and telephone number, or the like), user identification information, and external application account information, or the like, but is not limited to these. For example, when conducting electronic commerce on this information processing system or on an external system that is linked to this system by transmitting or receiving related information, the user information may include payment information (such as credit card information or the like), subscription purchase product information, and consolidatable target information, etc.

Delivery payload information stored in the delivery payload information storage part 122 may include, for example, delivery payload identification information, user identification information, storage container type information, size information (depth, width, height), weight information, controlled temperature range information, presence of perishable goods information, top/bottom stacking possibility information (top stacking or bottom stacking possibility information), delivery schedule information (scheduled delivery start time, scheduled delivery end time, scheduled delivery time slot information), subscription delivery reservation information, consolidation target delivery information, etc., but these are not limited to these.

The delivery information stored in the delivery information storage part 123 may include, for example, delivery identification information, user identification information, delivery payload identification information, remaining space information, delivery payload information for consolidation, delivery type information, and delivery schedule information (delivery start time information, delivery end time information, and scheduled delivery time slot information), delivery cost information, etc. In addition, it may also include storage container type information, weight information, temperature range information, presence of perishable goods information, subscription delivery reservation information, etc., which are linked to the delivery payload information, but these are not limited to these.

The information transmission/reception part 100 sends various information (including requests) to external devices (e.g., user terminals 2, worker terminals 3, etc.) that are directly or indirectly connected to the management server 1 via a network, and receives various information (including requests) from external devices.

The screen information generation part 110 generates screen information that is displayed via the user interface of the user terminal 2 or the worker terminal 3. The screen information can be user interface screen information that is generated by arranging various images and text based on predetermined layout rules, using images and text data stored in storage 12 as resources. In addition, the screen information generation part 110 may be a function part executed by the control part 20 using the application (including web browsers) stored in each user terminal 2, etc. In other words, it is also possible to transmit the necessary information from the management server 1 to generate the user interface screen, such as image data, and to have the application in user terminal 2, etc. generate the user interface screen based on the necessary information and display it on the user terminal 2, based on the specified layout rules. The processing related to the screen information generation part 110 can also be executed by a GPU (Graphics Processing Unit).

The data management part 120 performs data management such as sending various information received by the information transmission/reception part 100 to various function parts and acquiring various information from various function parts. The predetermined processing in the data management part 120 includes various processing, including the following processing, but is not limited to these: a residual space calculation process that calculates the residual space within the storage space based on user delivery information that includes storage container type information indicating the type of storage container for each volume of the storage container that stores the delivery payload for the user and reference storage space volume information indicating the volume of the storage space that stores one or more storage containers; a delivery schedule determination process that determines the delivery schedule for the delivery payload based on the aforementioned residual space information and certain predetermined conditions related to the delivery; a delivery information update process that updates (including adding) the consolidation target delivery payload information (such as consolidation target delivery payload identification information) contained in the delivery information.

The shape of the storage container should be a geometric solid container, and considering factors such as storage in the storage space and stacking, a rectangular parallelepiped (including a cube) is preferable. The material of the storage container can be any material, such as paper, plastic, or metal, and in particular, it is desirable from the perspective of ease of production and weight to be made of paper or plastic corrugated cardboard. In this disclosure, the type of storage container is set so that the type of storage container can be identified for the stored items, such as deliveries. The types of storage containers, for example, may include types of multiple storage container volumes that are set to be distinguishable from each other based on the volume obtained by dividing the reference storage space volume, which serves as the standard storage space volume, by a predetermined number (for example, an integer). These may include types of multiple storage container volumes that are set to be distinguishable from each other based on the volume obtained by dividing the reference storage space volume by a predetermined number (for example, an integer) and then multiplying by a number not exceeding the predetermined number (for example, ⅓, ⅔, 1, or ¼, ½, ¾, 1, etc.), as well as types of multiple storage container volumes that are set to be distinguishable from each other based on the volume obtained by dividing by a predetermined number (for example, an integer) and particularly by a power of 2 (n is an integer and may include 0) (for example, ½, ¼, ⅛, etc.), and it is not limited to these. Furthermore, with regard to the volume of the storage container, more specifically, for example, when the standard storage space volume is divided by 4 (i.e., when it is divided by ¼), it may be a storage container with a volume obtained by dividing either the depth, width, or height of the storage space by 4, or it may be a storage container with a volume obtained by dividing two of the depth, width, and height of the storage space by 2.

Furthermore, the standard storage space volume does not have to be the same as the predetermined storage space volume, but may be substantially the same (substantially the same). In particular, it may be a volume reduced by the amount of extra space (e.g. a few millimeters or centimeters) required in view of the work of storing containers in the storage space. In addition, if a partition is installed inside the container, the volume may be reduced by the amount of the partition (e.g. a few millimeters or centimeters) (or, if the storage space is substantially the same volume as the standard storage space volume, it may be larger by the amount of the partition).

The storage space for the user's stored items and/or the storage space targeted for the standard storage space volume may be based on any space with a predetermined volume. However, it is preferable that the storage space is for receiving stored items, and more specifically, it may be a storage space for items used by the user, such as a storage space for the user, a delivery box with a smart lock installed in a private residence, or a delivery box placed in a common area for a multi-unit residence, or a storage space for a shelf or locker that does not involve electrical locking and unlocking control, a private mailbox, or a cold storage box. For the delivery box storage space, the location of the space may be determined in advance by linking it to information related to the user, or it may be the location where the load is stored by the delivery person by linking it to information related to the user. It may also be a movable object such as the storage part of a moving object (such as a UAV or UGV, especially an autonomous moving object) used to deliver a load, a load carrier (such as a truck bed, a motorcycle rear box, a box dolly, or a basket dolly) used by a delivery person for delivery, or a delivery bag. Furthermore, the space with a predetermined volume may be a space with a predetermined length in the depth, width, and height directions as described above, but it may also be a space with a volume that has a virtually set length in the height direction for a region with a predetermined length in the depth and width directions, such as a pallet. Furthermore, this is not limited to these examples. In addition, the storage space to be stored and the reference storage space may be the same, or the storage space to be stored may be a size equal to a predetermined number (in particular, an integer) multiplied by the reference storage space.

The delivery management part 150 performs information registration such as adding delivery identification information and associating user identification information in the delivery information storage part 123 in accordance with, for example, delivery payload acceptance processing, such as reading the identification code (for example, reading 2D barcodes, RFID tags, NFC, etc.) attached to the delivery payload using readers (for example, readers operated by workers, stationary readers, readers on work robots (especially autonomous work robots)), or inputting the delivery payload information by workers, etc. In addition, when processing the acceptance of a delivery payload, when the delivery payload has not yet been stored in a storage container with a set storage container type, it may be stored in each storage container, or a known box-packing calculation algorithm may be used to store a predetermined object in a predetermined volume of space based on size information, etc., so that the storage container type information is linked to the delivery payload information.

The residual space calculation part 151 calculates the residual space (i.e. the so-called empty space) within the target storage space based on the reference storage space volume information indicating the volume of the storage space that stores one or more storage containers, and the storage container type information (i.e. including the storage container type information as delivery payload information linked to the delivery information) acquired in accordance with the delivery information. The residual space is calculated using a known box-packing calculation algorithm for storing a given object in a given volume of space. In particular, where the storage container type is specified for each predetermined volume of the reference storage space volume in accordance with the predetermined rules as described above, the residual space can be easily converted into a volume value that is easy to convert into a storage container type, making it easier to obtain residual converted storage container type information by converting the residual space into a storage container type. It becomes easier to calculate the residual space within the storage space, in particular, when the depth, width, or height of the storage space is set to be identifiable in terms of the storage container volume, which is calculated by dividing the above-mentioned predetermined number by a predetermined number and multiplying by a number less than the predetermined number, or when the types of storage container volume, which are set to be identifiable for each storage container volume divided by a predetermined number. In addition, when the storage space is divided into sections corresponding to one of the container types using partitions or other means, the delivery information storage part 124 stores partition area identification information that can be identified for each area divided by partitions, etc. in the target storage space, in association with the delivery identification information. It also stores the corresponding storage container type information for the partition area identification information. The residual space calculation part 151 may use the partition area identification information as the residual space information.

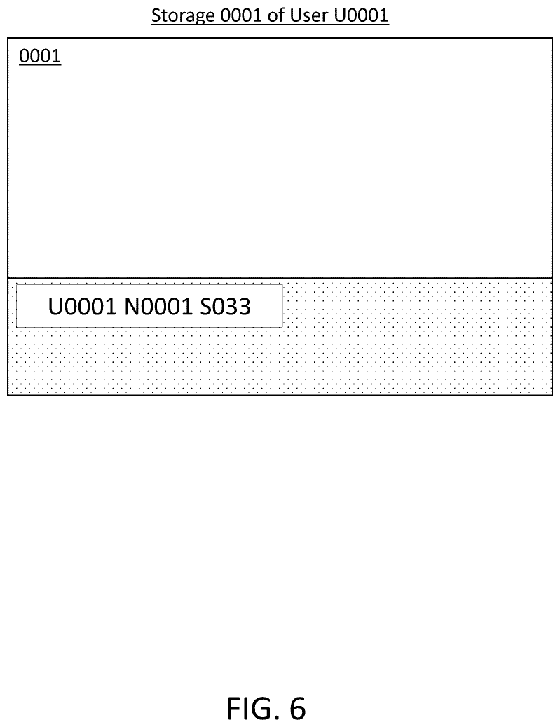

Here, FIG. 6 is used to provide a simplified example of calculating residual space in the case where the type of storage container is specified for each predetermined volume relative to the reference storage space volume. The example given here is for the types of storage container volume (e.g. ⅓, ⅔, 1) that can be identified by dividing the reference storage space volume by 3 and multiplying by a number not exceeding 3.

First, the user information “U0001” is linked to the storage space associated with the delivery identification information “0001”. When a delivery payload (delivery payload information “N0001”) is stored in a container (storage container type “S033”) that is one third of the reference storage space volume, since the delivery payload is stored in a storage space that has not yet been filled, the residual space information is updated to “⅔” by subtracting 1 from ⅓, and the residual converted storage container type information is updated to indicate two “S033”s and/or one “S066” (storage container type information indicating a container that is two-thirds the reference storage space volume).

Similarly, when a delivery payload (delivery payload information “N0010”) is stored in a container that is one-third of the reference storage space volume (storage container type “S033”), in order to store it in the storage space that already contains the delivery payload (N0001), the residual space information is updated from ⅔ to “⅓” by subtracting ⅓, and the residual converted storage container type information is updated as information indicating that there is one “S033” container.

As shown in the example, calculating the residual space in this way becomes more straightforward when the depth, width or height of the storage space is divided by a predetermined number. Furthermore, as mentioned above, it is possible to calculate the residual space using a known box-packing calculation algorithm, and in that case, it may be possible to reorganize the storage locations of the stored delivery payloads.

In addition, when the storage space is divided into separate areas corresponding to one of the storage container types, such as by partitions, etc., rather than storing in the common area within the storage space as in the above example, the residual space information may be the partition area identification information without any association with the stored items, and the residual converted storage container type information may be the corresponding storage container type information corresponding to the partition area identification information without any association with the stored items. The location of the partitions can be adjustable. The corresponding storage container type information can be changed (for example, “S033” can be changed from two containers to one “S066” container, or vice versa). In addition to one corresponding storage container type information (e.g., “S066”) corresponding to each partition area identification information, there may also be multiple corresponding storage container type information (e.g., two “S033”) associated with it instead of or in addition to this.

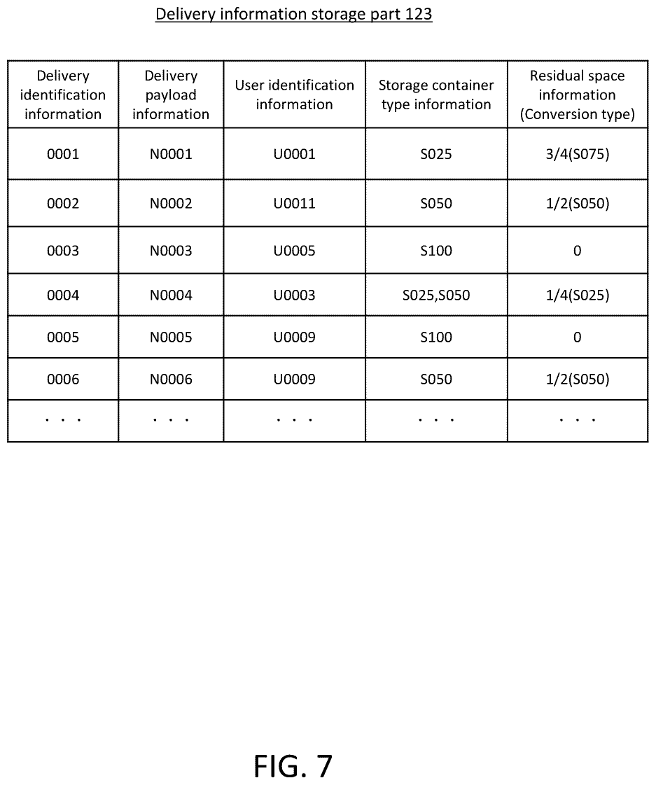

Here, using FIG. 7, an example of the information (in particular, residual space information) stored in the delivery information storage part 123 is shown. First, for the delivery identification information “0001”, it is shown that the delivery payload information is “N0001” and the user information is “U0001”, and that one storage container type information, “S025”, indicating a container type that is one quarter of the reference storage space volume, is stored. Therefore, the residual space information is calculated as “¾” (residual converted storage container type information indicates a container type that is three-quarters of the reference storage space volume, “S075”).

Next, for the delivery identification information “0002”, the linked delivery payload information is “N0002” and the user information is “U0011”, and it is shown that one “S050” storage container type information, which indicates a container type that is half the reference storage space volume, is stored. Therefore, the residual space information is calculated as “½” (residual conversion storage container type information indicating the container type for one-half of the reference storage space volume information “S050”).

Next, for the delivery identification information “0003”, the linked delivery payload information is “N0003” and the user information is “U0005”, and it is indicated that one “S100” storage container type information, which indicates a container type that is substantially the same as the reference storage space volume, is stored, so the residual space information is calculated as “0” (i.e., no space available).

Next, for the delivery identification information “0004”, the delivery payload information is “N0004” and the user information is “U0003”, and it is shown that the storage container type information contains one of the above-described “S025” (with the top stacking prohibition indicated by the top stacking possibility information) and one “S050”. Therefore, the residual space information is calculated as “¼” (residual conversion storage container type information indicates a container type that is one-quarter of the reference storage space volume information “S025”).

Finally, for the delivery identification information “0005” and “0006”, the linked delivery payload information is “N0005” and “N0006”, and the user information is “U0009”, and as storage container type information, it is shown that one “S100” and one “S050” are stored, so the residual space information is calculated as “0” and “½”. In this case, the actual residual space for the user of user information “U0009” for this delivery can be said to be “½” (residual conversion storage container type information indicates a container type of half the reference storage space volume, “S050”).

In this way, the residual space calculation part 151 is able to calculate the residual space within the target storage space based on the reference storage space volume information, which indicates the volume of the storage space that contains one or more storage containers, and the storage container type information, which indicates the type of each storage container volume that contains the delivery payload to the user. In particular, by setting identification information that can be identified for each storage container volume obtained by dividing the predetermined storage space volume by a predetermined number as the reference storage space volume, it becomes possible to store delivery payloads in the storage space efficiently, like a puzzle, and it becomes possible to clarify the residual space volume as residual conversion storage container type information. Using this, it becomes possible to determine delivery schedule information (e.g., delivery schedule time information (scheduled start time, scheduled end time, scheduled time slot) etc.) related to the user's delivery payload. This is described in detail below.

The delivery schedule determination part 152 determines the delivery schedule for the user's delivery payload based on at least the residual space information and the predetermined conditions related to delivery. More specifically, for example, if the volume indicated by the residual space information is smaller than a predetermined volume (e.g., smaller than the volume of the smallest storage container type used for delivery), the delivery schedule already stored is determined as the confirmed delivery schedule, but if the volume indicated by the residual space information is equal to or greater than the predetermined volume, the delivery schedule already stored is determined by updating it based on the predetermined conditions, etc. The predetermined conditions include, for example, update conditions that allow the delivery schedule to be updated, and update restriction conditions that do not allow the delivery schedule to be updated.

Example 1 of an update condition is, for example, when the user has accepted a consolidation request from another user related to the user, and it is not possible to store the other user's delivery payload in the user's pre-update delivery schedule in time. In such a case, it is possible to update the pre-update delivery schedule to a delivery schedule that allows storage of the other user's delivery payload in time. In cases where the storage of another user's delivery payload can be accommodated in the user's pre-update delivery schedule, the pre-update delivery schedule may be used as the finalized delivery schedule. In this case, the delivery charges indicated by the delivery charge information related to the user's delivery may be divided between the user and another user in a predetermined ratio (e.g. split in two), and the delivery charge information after the division may be stored with each of them, and each user may perform the payment processing. Alternatively, it may be possible to link and store only the delivery fee for a single delivery for either the user or another user, and then process the payment.

As a result, users will be more likely to accept consolidation requests in order to take advantage of the benefits of having delivery charges grouped together into one delivery, and this will also benefit the service provider by reducing the number of deliveries. In addition, if there is no need to necessarily have the other user bear the cost, such as when the relationship between the user and the other user is that of parent and child, etc., and the users share a common livelihood, the user may process the payment for the delivery charges that have been bundled into a single delivery.

In this case, the other user is a user corresponding to the other user identification information associated with the user identification information. Other user identification information may be, for example, co-residence user identification information set as a family member or partner, or proxy user identification information set by the user as a proxy recipient. In this example, for the purpose of such association, for example, the user may execute a registration process for the other user's identification information on the user's side application, and/or execute a process to select whether or not to allow association with the user's identification information on the other user's side application, etc.

Example 2 of the update conditions is, for example, when the user is allowed to send a consolidation request to another user, and the user's pre-update delivery schedule does not allow for the storage of the other user's delivery payload in time. In such cases, it may be acceptable to update the pre-update delivery schedule to a delivery schedule that allows for the storage of the other user's delivery payload in time. In addition, if the storage of another user's delivery payload can be accommodated in the user's pre-update delivery schedule, the pre-update delivery schedule may be used as the finalized delivery schedule. In this case, the delivery charges indicated by the delivery charge information related to the user's delivery may be divided between the user and another user in a predetermined ratio (e.g. split in two), and the delivery charge information after the division may be stored with each of them, and each user may perform the payment processing individually. Alternatively, it may be possible to link and store only the delivery fee for a single delivery for either the user or another user, and then process the payment.

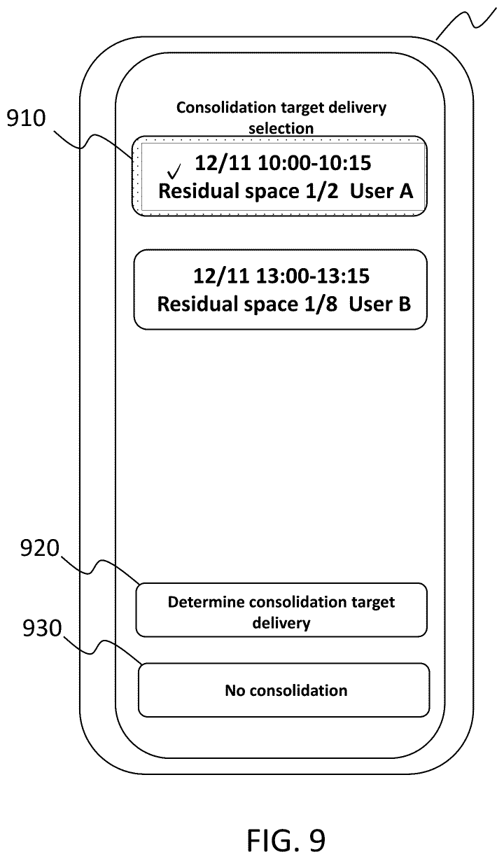

When a user requests a consolidation request to another user, for example, as shown in FIG. 9, the application on the user terminal 2 may extract the deliveries of other users with a similar delivery schedule (e.g., a difference in the delivery start time of less than a specified time), and present a list of consolidation target delivery information 910, and the consolidation request may be made to the other user in response to the selection operation for the other user's consolidation target delivery information 910 and the determination operation for the consolidation target delivery determination area 920. In this example, it is shown that the delivery schedule information “10:00-10:15” is selected by the user and the display of the consolidation target delivery information changes to a different display from the unselected consolidation target delivery information. Furthermore, rather than presenting it in the form of consolidation target item list information, the system may present the user with a selection of a predetermined number of consolidation target delivery information items as options in the user's application, allowing the user to make a selection and determine the consolidation target delivery; or the system may present the user with a consolidation confirmation notice of a predetermined number of consolidation target delivery information items extracted, allowing the user to make a selection and determine whether or not to consolidate the delivery; or the system may determine the consolidation target delivery without user intervention from among the extracted consolidation target delivery candidates. In addition, if there are no suitable items among the consolidation target delivery information 910 displayed on the application, and there is a determination operation to the consolidation rejection determination area 930, or if there is no delivery information that is a candidate for consolidation, if there is no selection of consolidation target delivery information by a specified period before the user's scheduled delivery time, the data management part 120 (in particular, the delivery management part 150) may update the user's delivery payload information and delivery information, such as by updating the delivery type information to indicate individual delivery without consolidation, or by calculating the residual space and updating the residual space information contained in the delivery information.

In this way, in this example 2 of the update conditions, unlike the above example 1 of the update conditions, the user is making a consolidation request to another user. As a result, the user will request a consolidation request in order to obtain the benefit of having the delivery charges for one delivery consolidated, and as a result of this, the number of deliveries will decrease, so the service provider will also benefit. In addition, if there is no need to necessarily have the other user bear the cost, such as when the relationship between the user and the other user is that of parent and child, etc., and the users share a common livelihood, the user may process the payment for the delivery charges that have been bundled into a single delivery.

Example 3 of the update conditions is a delivery that is automatically scheduled at a time based on the user's recurring delivery reservation information, and where the other user's delivery payload cannot be stored in the user's pre-update delivery schedule. The subscription delivery reservation information may be set based on the subscription purchase information contained in the user information, for example. In such cases, the pre-update delivery schedule may be updated to a delivery schedule that allows for the storage of other users' delivery payloads in time. In cases where the delivery schedule of another user can be accommodated in the user's pre-update delivery schedule, the pre-update delivery schedule may be used as the finalized delivery schedule. In this case, the delivery charges indicated by the delivery charge information related to the user's delivery may be divided between the user and another user in a predetermined ratio (e.g. split in two), and the delivery charge information after the division may be stored with each of them, and each user may perform the payment processing. Alternatively, it may be possible to link and store only the delivery fee for a single delivery for either the user or another user, and then process the payment.

As such, in this example 3 of updated conditions, unlike the above-mentioned example 1 of updated conditions, it is not necessary for the user to give permission for consolidation to other users. This is because scheduled deliveries that are automatically reserved based on subscription delivery reservation information often do not require immediate delivery, as long as the delivery period is not significantly changed. As a result, users can benefit from the advantage of having their delivery charges combined into a single delivery, and service providers also benefit from the reduced number of deliveries. In addition, if there is no need to necessarily make other users bear the cost, such as when the relationship between the user and another user is that of parent and child, etc., and the users share a common livelihood, the user may process the payment for the delivery charges that have been bundled into a single delivery. In addition, even if it is a subscription delivery based on subscription delivery reservation information, the user may be able to set it so that it is not subject to consolidation, or to set it so that permission is required when it is subject to consolidation.

On the other hand, example 1 of the update restriction conditions is, for example, that the control temperature range information (i.e., the control temperature range information of the delivery payload) linked to the user's delivery is information indicating a predetermined control temperature range. The specified temperature control range may be a temperature range lower than room temperature (e.g., approximately −5 to 5° C. or below −15° C.), or a temperature range higher than room temperature (e.g., approximately 25° C. or above), rather than a temperature range of room temperature (e.g., approximately 10 to 15 or 20° C.). In cases where one of these temperature ranges is indicated, the updated delivery schedule may be confirmed as the final delivery schedule without waiting for other deliveries. However, this does not mean that consolidation is rejected outright. If the consolidation of other users' deliveries into the pre-update delivery schedule is completed in time and the temperature control ranges are the same, consolidation is allowed. In such cases, the delivery charges indicated in the delivery charge information related to the user's delivery may be divided between the other users in a predetermined ratio (e.g. split in two), and the delivery charge information after the division may be stored with each user, and each user may perform the payment processing. Alternatively, it may be possible to link and store only the delivery charge for one delivery for either the user or another user, and to process the payment.

In this way, in this example 1 of the update restriction conditions, deliveries in temperature ranges that are difficult to control are handled without updating the schedule, so in cases where freshly made food is to be delivered immediately, it can be delivered at a temperature that is favorable to the user.

Example 2 of the update restriction conditions is, for example, that the information indicating whether or not the user's delivery includes a perishable good is information indicating that it includes a perishable good. In such cases, the pre-update delivery schedule may be used as the final delivery schedule without waiting for other deliveries. However, this does not reject consolidation itself, and if it is possible to consolidate with other users' deliveries in the pre-update delivery schedule, consolidation is allowed. In such cases, the delivery charges indicated by the delivery charge information related to the user's delivery may be divided between the user and another user in a predetermined ratio (e.g. split in two), and the delivery charge information after the division may be stored with each of them, and each user may perform the settlement processing. Alternatively, it may be possible to link and store only the delivery fee for a single delivery for either the user or another user, and then process the payment.

In this way, in this example 2 of update restriction conditions, delivery payloads containing a perishable good (particularly fresh fish, meat and other fresh foods) are handled without updating the schedule, so they can be delivered in a way that is favorable to the user.

Example 3 of the update restriction conditions is, for example, that the delivery type information linked to the user's delivery is information indicating that it is an express delivery (a delivery with a shorter period until completion than a normal delivery) or a time-specified delivery, rather than a normal delivery. The delivery type information may be set by the user on the application when the user makes a delivery request. In such cases, the pre-update delivery schedule may be used as the final delivery schedule without waiting for other deliveries. However, this does not reject consolidation itself, and if it is possible to consolidate the delivery schedule of another user into the pre-update delivery schedule, consolidation is allowed. In such cases, the delivery charges indicated in the delivery charge information related to the user's delivery may be divided between the user and other users in a predetermined ratio (e.g. split in two), and the delivery charge information after the division may be stored with each user, and each user may perform the payment processing. Alternatively, it may be possible to link and store only the delivery charge for one delivery for either the user or another user, and then process the payment.

In this way, in example 3 of the update restriction conditions, the delivery payload that the user wants to be delivered more quickly than usual or at a specified time is handled without updating the schedule, so it can be delivered at a time that is favorable to the user.

Furthermore, as another example of the conditions, it may be determined whether or not the delivery linked to the user meets the conditions for the objects that can be consolidated, as shown in the information on the objects that can be consolidated. In other words, for example, a condition for a package that can be consolidated could be that the delivery for the target user is included in the user-specified delivery time slot (e.g. during the daytime). This is because, for example, it may be undesirable for a user who wishes to consolidate deliveries to be consolidated during the nighttime if they are a proxy recipient who does not live with the user. Alternatively, for example, a condition for eligible items for consolidation could be that the other user who is requesting consolidation is another user who allows at least part or all of the delivery costs to be borne by them. This is because there may be cases where users prefer to have their delivery costs reduced rather than having their delivery made at the time they have reserved.

### <Processing Flow>

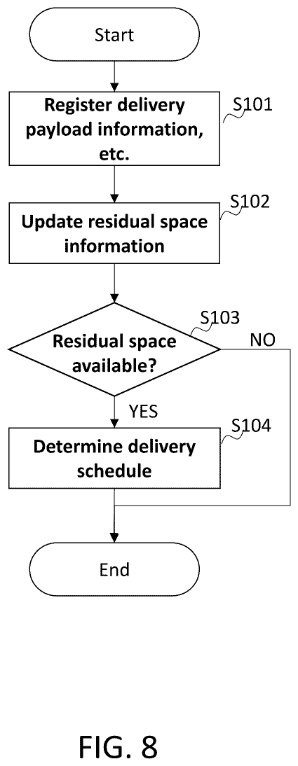

Referring to FIG. 8, the flow of the information processing method executed by the information processing system of this disclosure is explained. FIG. 8 is a flowchart showing an example of the processing of the information processing system of FIG. 1.

Here, the user or operator who uses the information processing system provided by this system may access the management server 1 using an application (including a web browser), etc., and if they are using the service for the first time, they may perform the user registration process and log in, or if they have already obtained an account, they may log in by receiving the prescribed authentication, for example by entering their ID and password, and then the service may be used. Alternatively, the service may be made available using the unique application ID associated with the application downloaded to the user terminal 2 or operator terminal 3 as the user identification information (ID). After this login authentication, the service can be used via applications (including web browsers).

First, in this example, the data management part 120 (in particular, the delivery management part 150) of the management server 1 generates new delivery payload identification information and delivery identification information in response to delivery payload acceptance processing, such as reading the identification code attached to the delivery payload using a reader, and executes the registration of delivery payload information and delivery information (S101).

Next, the residual space calculation part 151, based on storage container type information (which may be storage container type information as delivery payload information linked to delivery information) indicating the type of storage container for storing delivery payloads for users, and reference storage space volume information indicating the volume of the storage space that contains the relevant storage container, calculates residual space information indicating the residual space within the relevant storage space, and then updates the corresponding delivery information (S102). In particular, it is preferable that the residual space information is residual conversion storage container type information that converts the residual space into a storage container type.

Then, in step S103, if it is determined that there is not enough residual space (e.g. there is no residual space for the smallest container type), the delivery schedule is determined by the delivery schedule determination part 152, and the flow ends as is. After that, if the delivery payload has already been stored in a storage container compatible with this system, it is stored in the storage space as is. If it has not yet been stored, it is stored in a storage container of a storage container type calculated by the data management part 120 based on the delivery payload information, etc., and then stored in the storage space before being delivered to the user.

On the other hand, if it is determined in step S102 that there is sufficient residual space (for example, there is residual space that can at least accommodate the smallest storage container type), the delivery schedule for the delivery payload is determined by the delivery schedule determination part 152 based on the predetermined conditions for delivery (S104). The predetermined conditions for delivery are as described above, and the delivery schedule is determined according to the predetermined conditions (e.g. update conditions or update restriction conditions).

After that, if the delivery payload has already been stored in a storage container compatible with this system, it is stored in the storage space as is. If it has not yet been stored, it is stored in a storage container of a storage container type calculated by the data management part 120 based on the delivery payload volume information, etc., and then stored in the storage space. The selected consolidation target objects are then stored in the residual space of the storage space, and the delivery is sent to the user.

In addition, when consolidation target deliveries are determined on the user's application or on this system, and a delivery schedule is determined, the relevant consolidation target delivery information and delivery schedule information may be displayed on the operator terminal 3 so that the operator can check it during the storage operation. Furthermore, based on the consolidation target delivery information and delivery schedule information, the equipment used for storing the delivery payload (such as a storage robot, storage arm, or movable storage platform) may be controlled autonomously to retrieve the user's delivery payload and other users' delivery payloads from the delivery payload management space (e.g., shelves) and store them in the same storage space.

As described above, by using storage container type information to standardize and manage delivery payloads (e.g. loads such as packages), it is possible to provide an information processing system and server, information processing method, and program that make it easier to grasp the overall quantity of delivery payloads and enable efficient storage in various storage spaces.

The above embodiments are merely examples to facilitate understanding of this disclosure, and are not intended to limit the scope of this disclosure. It goes without saying that this disclosure may be changed or improved without deviating from its purpose, and that this disclosure includes equivalents thereof.

### DESCRIPTION OF REFERENCE NUMERALS

1 Management server
2 User terminal

1. An information processing system, comprising:
a residual space calculation part that, based on storage container type information indicating the type of storage container for storing delivery payloads to users, and reference storage space volume information indicating the volume of the storage space that stores the storage container, calculates residual space information indicating the residual space within the storage space; and
a delivery schedule determination part that, based on at least the residual space information and a predetermined condition related to the delivery, determines the delivery schedule for the delivery payload.

2. The information processing system according to claim 1,
wherein the storage container type information is made mutually identifiable based on the volume obtained by dividing the reference storage space volume by a predetermined number, with the predetermined storage space volume serving as the reference storage space volume.

3. The information processing system according to claim 1,
wherein the residual space information is residual conversion storage container type information that converts the residual space into storage container types.

4. The information processing system according to claim 1,
wherein the condition is an update condition that enables the updating of the delivery schedule.

5. The information processing system according to claim 4,
wherein the update condition is that the user has approved a consolidation request from another user related to the user, and that it is not possible to store the delivery payload of the other user in the user's pre-update delivery schedule in time.

6. The information processing system according to claim 4,
wherein the update condition is that the other user related to the user has approved a request for consolidation, and that it is not possible to store the other user's delivery payload in the user's pre-update delivery schedule.

7. The information processing system according to claim 4,
wherein the update condition is that the delivery of the user is a subscription delivery with an automatically set delivery period, and that the storage of the other user's delivery payload cannot be completed in time for the user's pre-update delivery schedule.

8. The information processing system according to claim 1,
wherein the condition is an update restriction condition that does not allow the delivery schedule to be updated.

9. The information processing system according to claim 8,
wherein the update restriction condition is that the temperature control range information linked to the user's delivery is information indicating a specified temperature control range other than normal temperature.

10. The information processing system according to claim 8, wherein the update restriction condition is that the presence of perishable goods information linked to the user's delivery indicates that a perishable good is included.

11. The information processing system according to claim 8,
wherein the update restriction condition is that the delivery type information linked to the user's delivery is information indicating express delivery.

12. The information processing system according to claim 8,
wherein the update restriction condition is that the delivery type information associated with the user's delivery is information indicating a time-specified delivery.

13. The information processing system according to claim 1,
wherein the condition is whether the delivery linked to the user meets the condition of a consolidation target indicated in the consolidation target information.

14. The information processing system according to claim 13,
wherein the condition for the consolidation target is that the delivery for the target user is in the user-specified delivery time slot.

15. The information processing system according to claim 13,
wherein the condition for the consolidation target is that the other user who is requesting the consolidation is another user who permits the other user to bear at least part or all of the delivery costs.

16. The information processing system according to claim 1,
wherein when the delivery in the delivery schedule is consolidated with another user's delivery payload, the delivery charge information related to the user is divided between the other user and a predetermined ratio, and the delivery charge information after the division is stored linked to each user.

17. A server, comprising:
a residual space calculation part that, based on storage container type information indicating the type of storage container for storing delivery payloads to users and reference storage space volume information indicating the volume of the storage space that stores the storage container, calculates residual space information indicating the residual space in the storage space; and
a delivery schedule determination part that, based on at least the residual space information and predetermined conditions related to the delivery, determines the delivery schedule for the delivery payload.

18. An information processing method, comprising:
a step of, based on storage container type information indicating the type of storage container for storing the delivery payload to the user for each storage container volume and reference storage space volume information indicating the volume of the storage space that stores the storage container, calculating residual space information indicating the residual space within the storage space; and
a step of, based on at least the residual space information and predetermined conditions related to the delivery, determining the delivery schedule of the delivery payload.

19. (canceled)
